(19) United States
(12) Patent Application Publication
(10) Pub. No.: US 2014/0160373 A1
(43) Pub. Date: Jun. 12, 2014

(54) CAPACITIVE TOUCH PANEL AND FABRICATION METHOD THEREOF

(71) Applicant: WINTEK CORPORATION, Taichung City (TW)

(72) Inventors: Chang-Hsuan Hsu, Changhua County (TW); Wen-Chun Wang, Taichung City (TW); Cheng-Yi Chou, Yunlin County (TW); Chong-Wei Li, Changhua County (TW); Ching-Fu Hsu, Taichung City (TW); Chih-Yuan Wang, Taichung City (TW)

(73) Assignee: WINTEK CORPORATION, Taichung City (TW)

(21) Appl. No.: 14/098,554

(22) Filed: Dec. 6, 2013

(30) Foreign Application Priority Data
Dec. 7, 2012 (TW) 101146221

(51) Int. Cl. G06F 1/16

(52) U.S. Cl. CPC G06F 1/16
USPC 349/12; 427/79; 430/319; 430/318

(57) ABSTRACT

A capacitive touch panel includes at least one first conductive series extending along a first direction and at least one second conductive series extending along a second direction on a substrate. The first conductive series includes a plurality of first electrodes disposed along the first direction and a plurality of first connecting electrodes respectively disposed between two adjacent first electrodes. The second conductive series includes a plurality of second electrodes disposed along the second direction and a plurality of second connecting electrodes respectively disposed between two adjacent second electrodes. The first direction intersects the second direction. At least one kind of elements of the first electrodes, the first connecting electrodes, the second electrodes, and the second connecting electrodes are formed from a metal mash layer, and the first conductive series and the second conductive series are electrically isolated from each other.

### BACKGROUND OF THE INVENTION

1. Field of the Invention

The present invention relates to a touch panel and a fabrication method thereof, and more particularly, to a capacitive touch panel with a conductive mesh layer serving as electrodes and a related fabrication method.

2. Description of the Prior Art

In the conventional capacitive touch panel technologies, indium tin oxide (ITO) is commonly used as the material of transparent sensing electrodes because ITO is not only transparent but conductive. However, ITO still has electric impedance. The larger the size of the ITO layer is, the severer the impedance issues can be. If the size of the capacitive touch panel is large, the conductivity becomes uneven from regions to regions. In order to reduce the impedance, the ITO layer must be thicken, while the thicker ITO layer often damage the optical performance of the panel. Accordingly, to reduce the impedance of the sensing electrodes in the large-size and middle-size capacitive touch panels is a main objective in the field.

### SUMMARY OF THE INVENTION

It is one of the objectives of the present invention to provide a capacitive touch panel and a fabricating method thereof. And the electrodes of the capacitive touch panel include a conductive mesh layer to ensure better performance, thereby solving the high-impedance issues of the conventional capacitive touch panel owing to ITO.

To achieve the purposes described above, an embodiment of the present invention discloses a capacitive touch panel. The capacitive touch panel includes a substrate, at least one first conductive series and at least one second conductive series. The first conductive series is disposed on the substrate and extends along a first direction. The first conductive series includes a plurality of first electrodes disposed along the first direction and a plurality of first connecting electrodes. Each of the first connecting electrodes is disposed between two of the first electrodes adjacent to each other to electrically connect the first electrodes of the same first conductive series. The second conductive series is disposed on the substrate and extends along a second direction. The second conductive series includes a plurality of second electrodes disposed along the second direction and a plurality of second connecting electrodes. Each of the second connecting electrodes is disposed between two of the second electrodes adjacent to each other to electrically connect the second electrodes of the same second conductive series. At least one of the first electrodes, the second electrodes, the first connecting electrodes and the second connecting electrodes is formed from a conductive mesh layer. The first direction intersects the second direction. The first conductive series is electrically isolated from the second conductive series.

To achieve the purposes described above, an embodiment of the present invention discloses a fabrication method of a capacitive touch panel. The fabrication method includes forming a patterned conductive layer on a substrate, forming a plurality of patterned insulating layers on the substrate and forming a conductive mesh layer on the substrate. The patterned conductive layer includes a plurality of first connecting electrodes. Each of the patterned insulating layers corresponds to and partially covers one of the first connecting electrodes. The conductive mesh layer includes a plurality of first electrodes, a plurality of second electrodes and a plurality of second connecting electrodes. The second electrodes are arranged along a second direction to form a plurality of lines. Each of the second connecting electrodes is disposed between two of the second electrodes adjacent to each other in a same line along the second direction to electrically connect the second electrodes. All the second electrodes and the second connecting electrodes disposed in a same line along the second direction constitute a second conductive series. The first electrodes are arranged along a first direction to form a plurality of lines. Each of the first connecting electrodes is disposed between two of the first electrodes adjacent to each other in a same line along the first direction. Each of the first connecting electrodes is configured to electrically connect the two first electrodes adjacent to the first connecting electrode along the first direction. All the first electrodes and the first connecting electrodes disposed in a same line along the first direction constitute a first conductive series. The first direction intersects the second direction. Each of the first conductive series is electrically isolated from each of the second conductive series.

To achieve the purposes described above, an embodiment of the present invention further discloses a fabrication method of a capacitive touch panel. The fabrication method includes forming a conductive mesh layer on a substrate, forming a plurality of patterned insulating layers on the substrate and forming a patterned transparent conductive layer on the substrate. The conductive mesh layer includes a plurality of first electrodes arranged along a first direction to form a plurality of lines, a plurality of second electrodes arranged along a second direction to form a plurality of lines, and a plurality of second connecting electrodes. Each of the second connecting electrodes is disposed between two of the second electrodes adjacent to each other in a same line along the second direction to electrically connect the second electrodes. All the second electrodes and the second connecting electrodes disposed in a same line along the second direction constitute a second conductive series. Each of the patterned insulating layers corresponds to and partially covers one of the second connecting electrodes and partially covers two of the corresponding first electrodes. The patterned transparent conductive layer includes a plurality of first connecting electrodes. Each of the first connecting electrodes is disposed between two of the first electrodes adjacent to each other in a same line along the first direction to electrically connect the first electrodes. All the first electrodes and the first connecting electrodes disposed in a same line along the first direction constitute a first conductive series. The first direction intersects the second direction. Each of the first conductive series is electrically isolated from each of the second conductive series. Each of the first connecting electrodes partially covers one of the patterned insulating layers.

Because at least one of the first electrodes, the second electrodes, the first connecting electrodes and the second connecting electrodes in the capacitive touch panel of the present invention is formed from a conductive mesh layer, the impedance in large-size and middle-size touch panels is lower enough to ensure good signal delivering and sensing performance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a top-view schematic diagram locally illustrating a capacitive touch panel according to a first embodiment of the present invention.

FIG. 2 is a cross-sectional view diagram along a cross-sectional line A-A′ of the capacitive touch panel in FIG. 1.

FIG. 3 is a schematic diagram illustrating the conductive mesh pattern of a conductive mesh layer according to the present invention.

FIGS. 4-9 are schematic diagrams illustrating a fabrication method of the capacitive touch panel according to the first embodiment of the present invention.

FIG. 10 is a schematic diagram illustrating a capacitive touch panel according to a first variant embodiment of the first embodiment of the present invention.

FIG. 11 is a schematic diagram illustrating a capacitive touch panel according to a second variant embodiment of the first embodiment of the present invention.

FIG. 12 is a schematic diagram illustrating a capacitive touch panel according to a third variant embodiment of the first embodiment of the present invention.

FIGS. 13-16 are schematic diagrams illustrating a fabrication method of a capacitive touch panel according to a fourth variant embodiment of the first embodiment of the present invention.

FIG. 17 is a top-view schematic diagram illustrating a capacitive touch panel according to a second embodiment of the present invention.

FIG. 18 is a top-view schematic diagram illustrating a capacitive touch panel according to a third embodiment of the present invention.

FIG. 19 is a top-view schematic diagram illustrating a capacitive touch panel according to a variant embodiment of the third embodiment of the present invention.

FIGS. 20-21 are top-view schematic diagrams illustrating a capacitive touch panel according to a fourth embodiment of the present invention.

FIGS. 22-23 are top-view schematic diagrams illustrating a capacitive touch panel according to a fifth embodiment of the present invention.

FIGS. 24-25 are top-view schematic diagrams illustrating a capacitive touch panel according to a sixth embodiment of the present invention.

FIG. 26 is a top-view schematic diagram locally illustrating a capacitive touch panel according to a seventh embodiment of the present invention.

FIG. 27 is a partial cross-sectional view diagram of the capacitive touch panel of FIG. 26.

FIG. 28 is a partial cross-sectional view diagram of a capacitive touch panel according to an eighth embodiment of the present invention.

FIG. 29 is a partial cross-sectional view diagram of a capacitive touch panel according to a ninth embodiment of the present invention.

### DETAILED DESCRIPTION

To provide a better understanding of the present disclosure, features of the embodiments will be made in detail. The embodiments of the present disclosure are illustrated in the accompanying drawings with numbered elements.

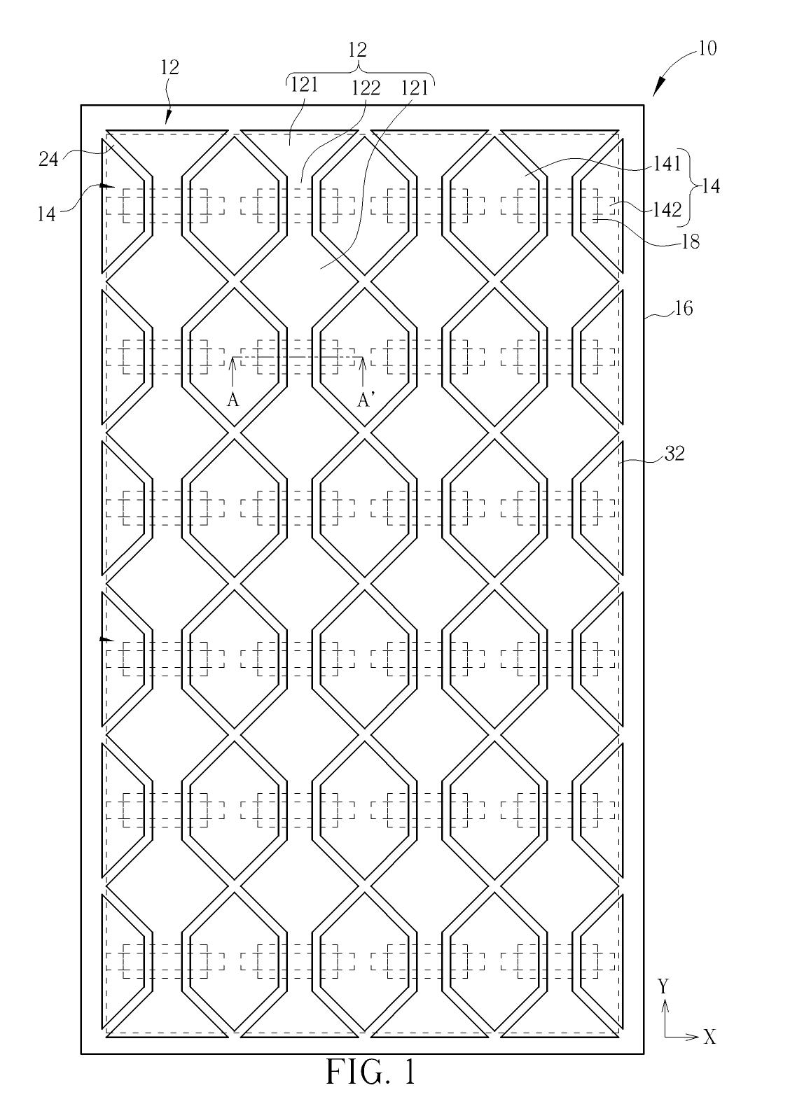

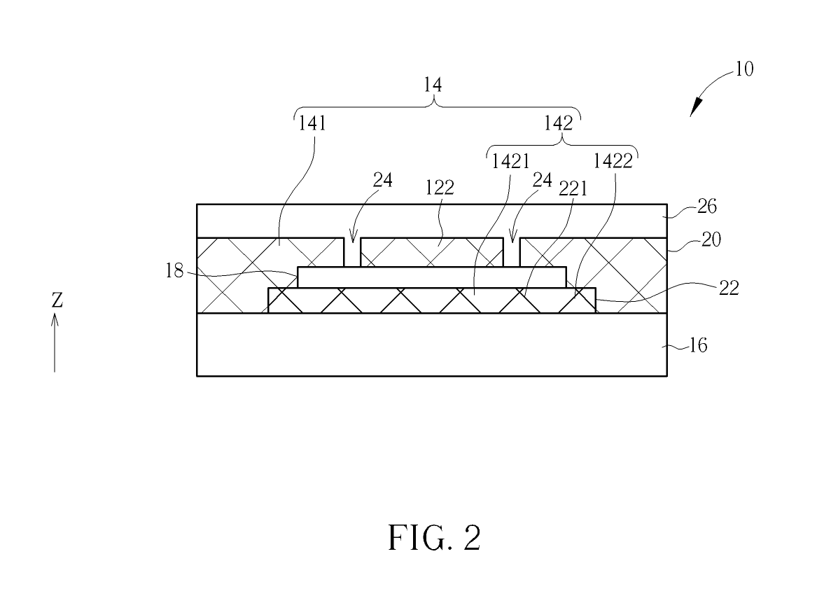

Referring to FIG. 1 and FIG. 2, FIG. 1 is a top-view schematic diagram locally illustrating a capacitive touch panel according to a first embodiment of the present invention, and FIG. 2 is a cross-sectional view diagram along a cross-sectional line A-A′ of the capacitive touch panel in FIG. 1. A capacitive touch panel 10 of the present invention includes a substrate 16, at least one first conductive series 14 and at least one second conductive series 12 disposed on the surface of the substrate 16. The substrate 16 may be a substrate composed of a soft material or a rigid material, such as a glass substrate, a strengthened glass substrate, a plastic substrate, a flexible cover lens, a flexible plastic substrate, for example, a plastic film, a thin glass substrate (i.e. glass film) or a substrate of the display. Herein, the above-mentioned strengthened glass substrate may be a cover lens, and a decoration layer (not shown) is disposed on at least one side of the cover lens, for example, disposed on a portion of the peripheral region or the entire area of the peripheral region. The above-mentioned substrate of the display may include a color filter substrate of a liquid crystal display or a package substrate of an organic light-emitting display. In this embodiment, the capacitive touch panel 10 includes a plurality of first conductive series 14 and a plurality of second conductive series 12. The first conductive series 14 extend along a first direction (i.e., the X direction in FIG. 1) to form a plurality of lines. The second conductive series 12 extend along a second direction (i.e., the Y direction in FIG. 1) to form a plurality of lines. The first direction intersects the second direction. Each of the second conductive series 12 includes a plurality of second electrodes 121 and a plurality of second connecting electrodes 122. Each of the second connecting electrodes 122 is disposed between and electrically connected to two of the second electrodes 121 adjacent to each other in the same second conductive series 12. The first conductive series 14 are also disposed on the substrate 16. Furthermore, the first conductive series 14 and the second conductive series 12 are disposed on the same surface of the substrate 16. Each of the first conductive series 14 includes a plurality of first electrodes 141 and a plurality of first connecting electrodes 142. Each of the first connecting electrodes 142 is disposed between and electrically connected to two of the first electrodes 141 adjacent to each other in the same first conductive series 14.

As shown in FIG. 2, the second electrodes 121, the first electrodes 141 and the second connecting electrodes 122 are formed from the same first conductive mesh layer 20. There is at least one gap 24 among the second conductive series 12 and the first electrodes 141 so as to electrically isolate the second conductive series 12 from the first electrodes 141. The first connecting electrodes 142 are formed from a conductive layer 22. Each of the first connecting electrodes 142 partially overlaps the corresponding second connecting electrode 122 along a third direction, which is perpendicular to the surface of the substrate 16 (i.e., the Z direction in FIG. 2). A plurality of patterned insulating layers 18 are further disposed on the surface of the substrate 16 and among the first connecting electrodes 142 and the corresponding second connecting electrodes 122 respectively so that the first connecting electrodes 142 are electrically isolated from the corresponding second connecting electrodes 122. Therefore, the second conductive series 12 are electrically isolated from the first conductive series 14. In addition, the capacitive touch panel 10 further includes a decoration layer 32, which is disposed on the substrate 16 and partially overlaps the second conductive series 12 and the first conductive series 14, as shown in FIG. 1.

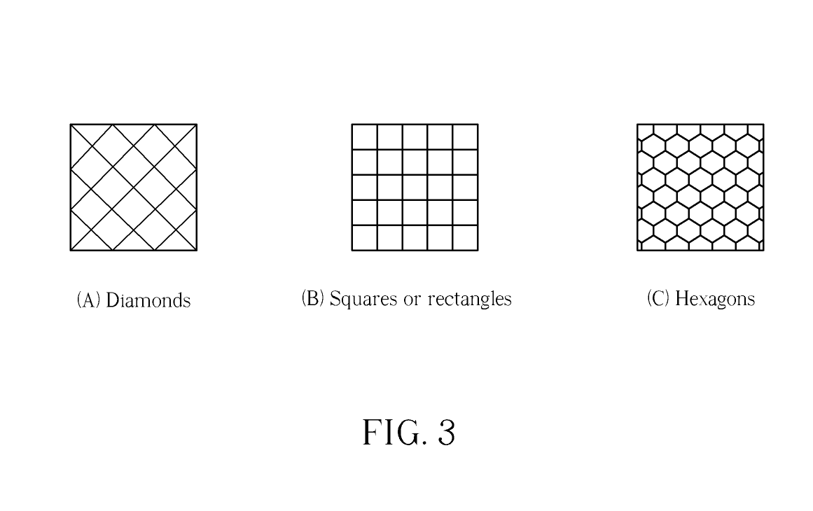

Referring to FIG. 3, FIG. 3 is a schematic diagram illustrating the conductive mesh pattern of a conductive mesh layer according to the invention. The mesh pattern of the first conductive mesh layer 20 may include continuously-stacked geometric shapes of all kinds of sizes and shapes in a periodic arrangement, wherein all the constituent geometric shapes preferably have the same size. In other words, the continuously-stacked geometric shapes in the first conductive mesh layer 20 is arranged in an ordered pattern continuously extending in all three spatial dimensions. For example, as shown in FIG. 3, the continuously-stacked geometric shapes may be diamonds (A), squares or rectangles (B), and hexagons (C), but not limited thereto. In addition, the conductive layer 22 forming the first connecting electrodes 142 may be a second conductive mesh layer. The mesh pattern of the second conductive mesh layer may be identical to that of the first conductive mesh layer 20. Selectively, the conductive mesh pattern of the second conductive mesh layer may include continuously-stacked geometric shapes with another kind of shape, size and/or density different from those of the first conductive mesh layer 20, but not limited thereto.

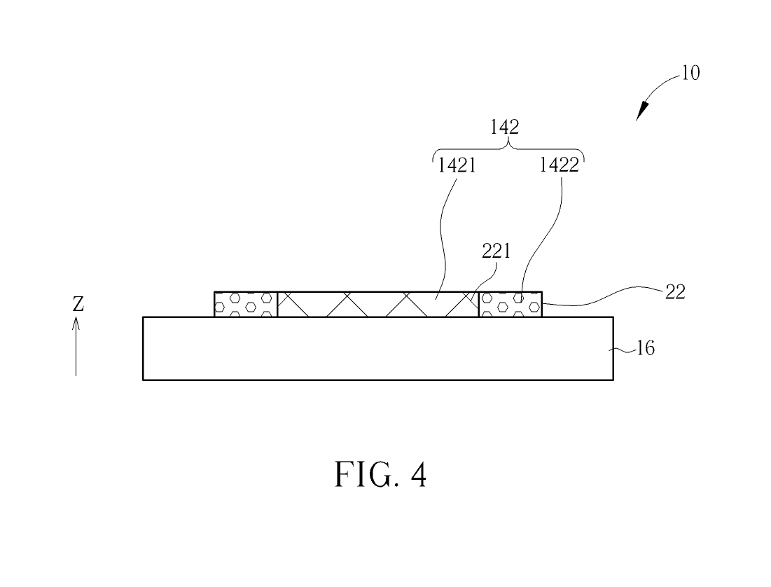

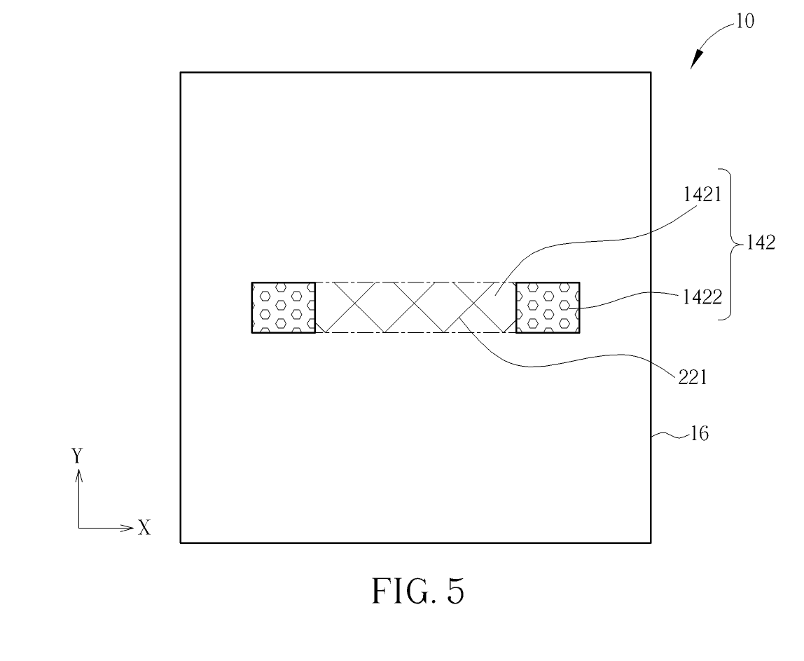

FIGS. 4-9 are schematic diagrams illustrating a fabrication method of a capacitive touch panel according to a first embodiment of the present invention and only present locally enlarged views of the capacitive touch panel corresponding to the region shown in FIG. 2. Referring to FIG. 4 and FIG. 5, according to the fabrication method of the capacitive touch panel of the present invention, a substrate 16 is first provided. Then, a conductive layer 22 is formed on the substrate 16. In this embodiment, the conductive layer 22 may be a metal layer. A plurality of first connecting electrodes 142 are formed by a photolithography process subsequently, wherein FIGS. 4-9 only show one first connecting electrode 142 for explaining. It is noteworthy that each first connecting electrode 142 may include a first portion 1421 and two second portions 1422. A portion of the first connecting electrodes 142 covered by the insulating layers 18 in the subsequent processes is referred to as the first portion 1421. The second portions 1422 respectively locate at both ends of the first portion 1421; moreover, at least one portion of the second portions 1422 is exposed by the insulating layers 18 formed subsequently. As shown in FIG. 4 and FIG. 5, after the photolithography process, the first portion 1421 of each first connecting electrode 142 may have a conductive mesh pattern 221 whose constituent geometric shapes are continuously stacked and arranged in an ordered pattern continuously extending in all three spatial dimensions. However, each second portion 1422 dose not have a conductive mesh pattern but is a complete block or stripe. The conductive mesh pattern 221 comprises a plurality of metal threads forming the continuously-stacked geometric shapes in a periodic arrangement. The width of the metal threads may be less or equal to about 100 micrometers. The fabrication of the first connecting electrodes 142 is not limited to the above-mentioned photolithography process. In other embodiments, the first connecting electrodes 142 may be formed by a screen printing process or other well-known or conventional conductive mesh processes.

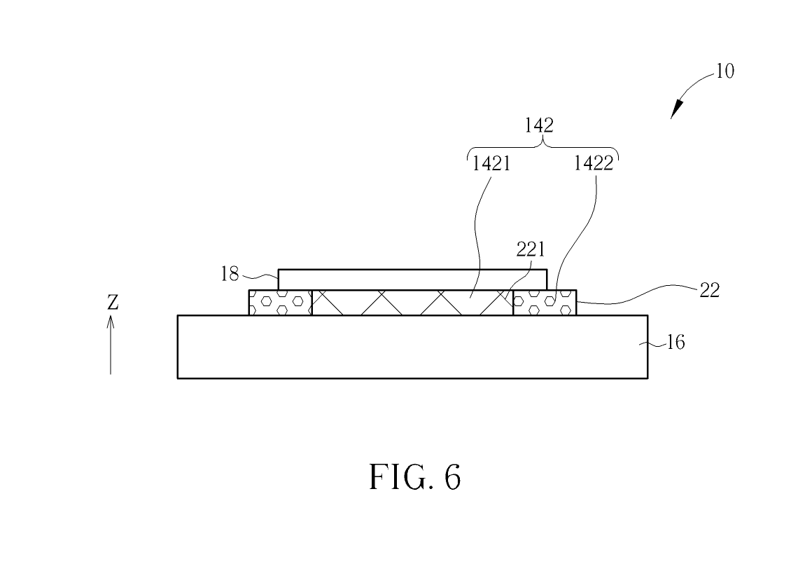

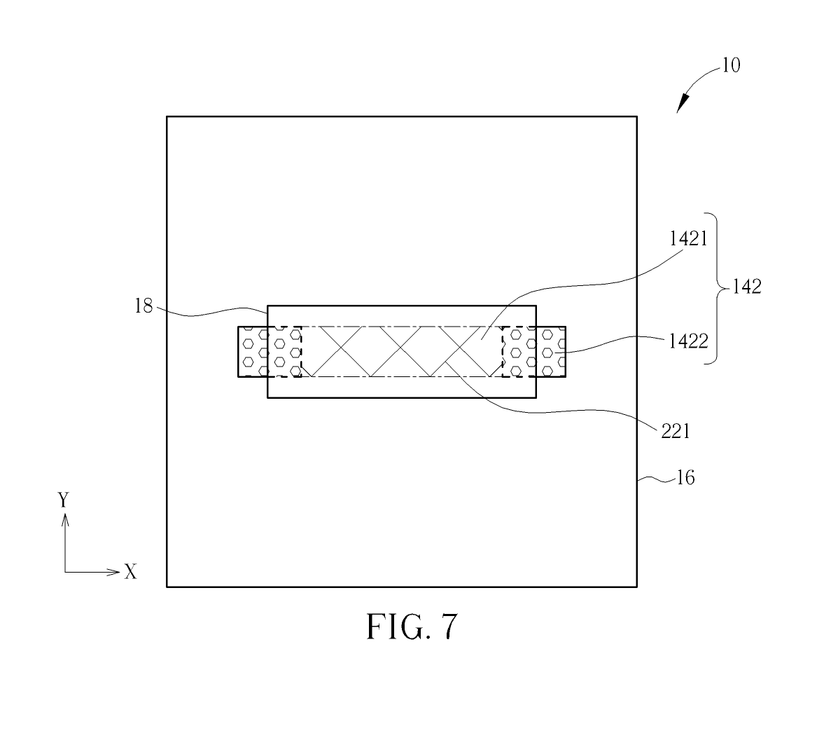

Referring to FIG. 6 and FIG. 7, an unpatterned insulating layer comprising insulating material is formed on the substrate 16. Then, the insulating layer is patterned by, for example, a photolithography process to form a plurality of patterned insulating layers 18 as shown in FIG. 6. The insulating layers 18 respectively cover the first portion 1421 of each first connecting electrode 142. In this embodiment, the part of the first portion 1421 near the two ends of the insulating layer 18 does not have the conductive mesh pattern 221 but is a block or a stripe similar to those of the second portions 1422. The size of the entire first portion 1421 and the second portions 1422 of the first connecting electrode 142 detailed in this embodiment are only for illustration. The real size and length are not limited to that shown in FIG. 4 and FIG. 5 and may be further modified according to different design considerations.

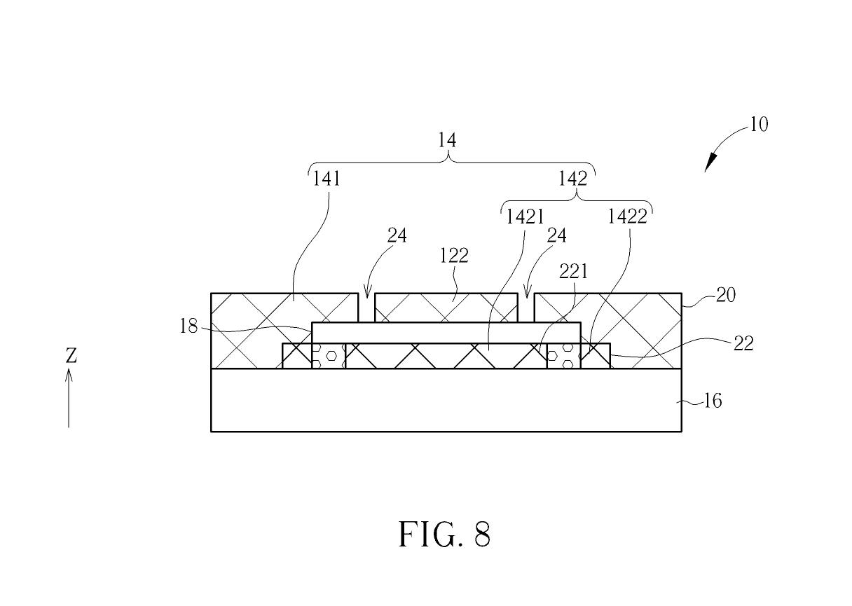

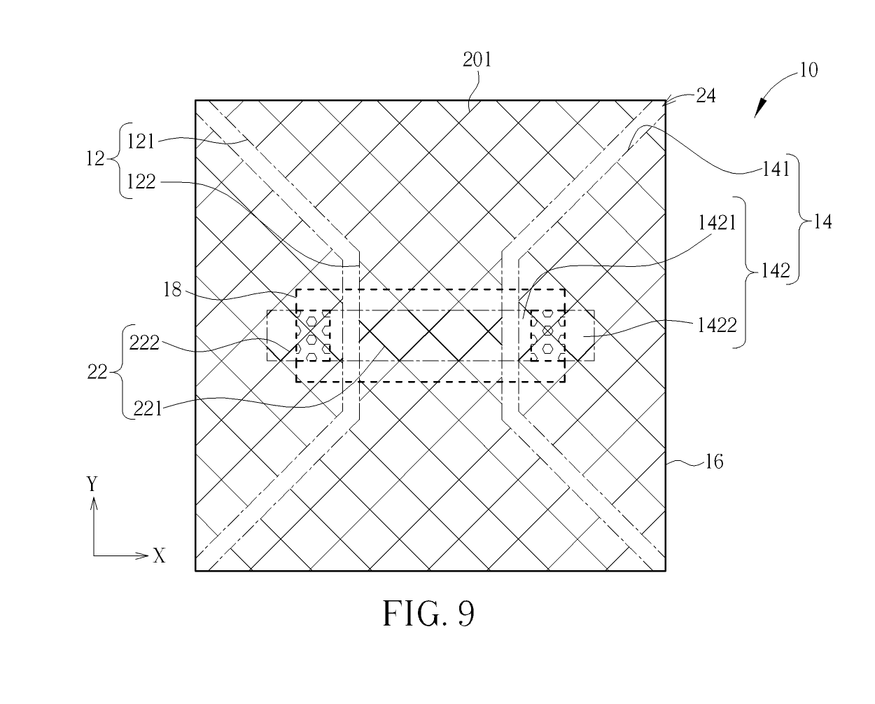

Referring to FIG. 8 and FIG. 9, a first conductive mesh layer 20 is then formed on the substrate 16. The first conductive mesh layer includes a conductive mesh pattern 201 with the continuously-stacked geometric shape. The conductive mesh pattern 201 comprises a plurality of metal threads forming the continuously-stacked geometric shapes in a periodic arrangement. In FIG. 8 and FIG. 9, a diamond is taken as an example of the continuously-stacked geometric shapes. The width of the metal threads of the conductive mesh pattern 201 may be less or equal to about 100 micrometers. The method of forming the first conductive mesh layer 20 may include, for example, blanketly forming a metal layer on the substrate 16 to cover the surface of the substrate 16. The metal layer may be formed by, for example, a sputtering process or a coating process. The material of the metal layer may be the same as or different from that of the conductive layer 22. The metal layer may then be patterned by, for example, a photolithography process to remove a portion of the metal layer and form the gap 24. At the same time, the conductive mesh pattern 201 is formed in the metal layer such that the second electrodes 121, the second connecting electrodes 122 and the first electrodes 141 have the conductive mesh pattern 201. The dashed line in FIG. 9 presents the areas of the second electrodes 121, the second connecting electrodes 122 and the first electrodes 141. In fact, only the portion of the second electrodes 121, the second connecting electrodes 122 and the first electrodes 141 with the conductive mesh pattern 201 comprise conductive materials. As shown in FIG. 9, there is no metal thread in the gap 24. When fabricating the first conductive mesh layer 20, the second portions 1422 of the first connecting electrodes 142 exposed by the insulating layers 18 are overlapped by the first electrodes 141 in the Z direction. Therefore, if the material property of the conductive layer 22 is similar to the material property of the first conductive mesh layer 20, the second portions 1422 will also be patterned in the patterning process—that is to say, the second portions 1422 will be etched at the same time in the photolithography process. Accordingly, the second portions 1422 of the first connecting electrodes 142 also have the conductive mesh pattern 222, which is identical to the conductive mesh pattern 201 of the first conductive mesh layer 20. In the cases, the region where the second portions 1422 of the first connecting electrodes 142 contact the first electrodes 141 has the same conductive mesh pattern (i.e., the conductive mesh pattern 222 and the conductive mesh pattern 201 respectively), so the second portions 1422 of the first connecting electrodes 142 and the first electrodes 141 are electrically connected to each other through the conductive mesh pattern 222 and the conductive mesh pattern 201. In other embodiments, the conductive mesh pattern 201 and the pattern of the second electrodes 121, the second connecting electrodes 122 and the first electrodes 141 as shown in FIGS. 8-9 may be formed in the first conductive mesh layer 20 by screen printing processes or other conventional process. It is noteworthy that if the first conductive mesh layer 20 is fabricated by a screen printing process or other conventional process that will not pattern the first connecting electrodes 142 exposed by the insulating layers 18 simultaneously, the conductive mesh pattern 222 may be formed in the second portions 1422 of the first connecting electrodes 142 in the stage shown in FIGS. 4-5 so that the visual performance can be optimized with the even and regular conductive mesh pattern. In other cases, the second portions 1422 of the first connecting electrodes 142 may be formed of transparent conductive materials and therefore no conductive mesh pattern is needed to be formed in the transparent second portions 1422. Then, a passivation layer (e.g., the passivation layer 26 shown in FIG. 2) is optionally formed on the surface of the substrate 16, covering the first conductive mesh layer 20 and filling the gap 24. Accordingly, the basic structure of the capacitive touch panel 10 of this embodiment in the present invention is accomplished.

The material of each of the aforementioned metal layers may comprise metal, for example but not limited to, at least one of aluminum (Al), copper (Cu), silver, chromium (Cr), titanium (Ti), molybdenum (Mo), neodymium (Nd), gold (Au), an alloy thereof, a composite layer thereof, and a composite layer of the above-mentioned materials and alloys of the above-mentioned materials. However, the present invention is not limited to this and may comprise other conductive materials. Moreover, for example, the above-mentioned composite layer may be a three-layer stacked structure, which comprises molybdenum (Mo), Al—Nd alloy (i.e., an alloy of aluminum and neodymium) and molybdenum (Mo) disposed in order, molybdenum (Mo), silver (Ag) and molybdenum (Mo) disposed in order, molybdenum (Mo), aluminum (Al) and molybdenum (Mo) disposed in order, or ITO/Ag/ITO, but the present invention is not limited to this and any stacked structure with the desired conductive properties is within the scope of the present invention.

It is noteworthy that the first portion 1421 and the second portions 1422 of the first connecting electrode 142 in this embodiment respectively have the conductive mesh pattern 221 and the conductive mesh pattern 222. The conductive mesh pattern 221 and the conductive mesh pattern 222 may have the same mesh shape, size and density; nevertheless, all of, just two of or just one of their mesh shape, size and density might be different. Additionally, in other embodiments, the whole the first connecting electrodes 142 may have an evenly distributed conductive mesh pattern, such as the conductive mesh pattern 222. In other words, all the first portion 1421 and the second portions 1422 of the first connecting electrodes 142 may have either the same conductive mesh pattern 222 or the same conductive mesh pattern 221.

The structure of the capacitive touch panel of the present invention and fabrication method thereof are not limited by the aforementioned embodiment, and may have other different preferred embodiments and variant embodiments. To simplify the description, the identical components in each of the following embodiments are marked with identical symbols. For making it easier to compare the difference between the embodiments, the following description will detail the dissimilarities among different embodiments and the identical features will not be redundantly described.

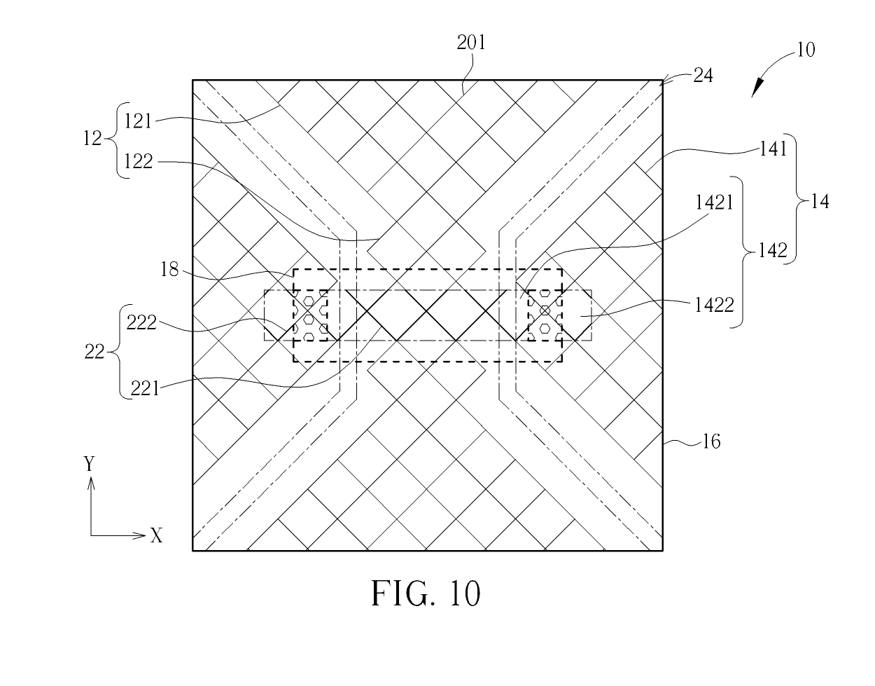

Referring to FIG. 10, FIG. 10 is a schematic diagram illustrating a capacitive touch panel according to a first variant embodiment of the first embodiment of the present invention. In the first variant embodiment of the first embodiment, since the gap among the metal threads of the second electrodes 121, the second connecting electrodes 122 and the first electrodes 141 are quite large to lead to disconnection (or open circuits), the conductive mesh pattern 201 in the second electrodes 121, the second connecting electrodes 122 and the first electrodes 141 all have complete geometric shapes, such as a diamond.

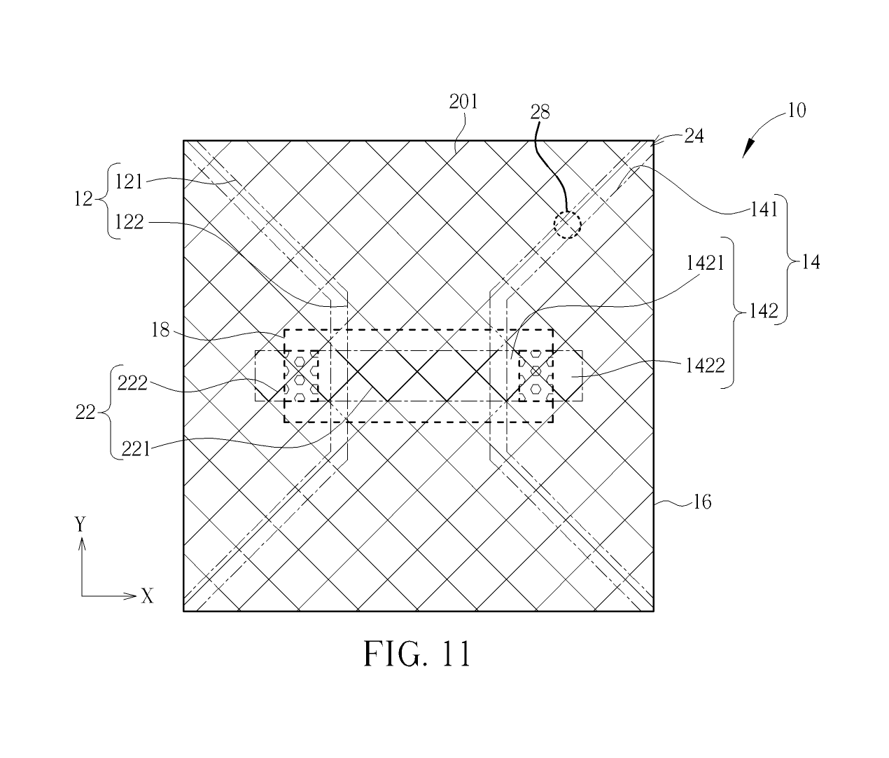

Referring to FIG. 11, FIG. 11 is a schematic diagram illustrating a capacitive touch panel according to a second variant embodiment of the first embodiment of the present invention. In the capacitive touch panel in the second variant embodiment of the first embodiment in the present invention, the broken-bond structure 28 is designed in the gap 24 where the first conductive series 14 is electrically isolated from the second conductive series 12 adjacent to the first conductive series 14. In other words, each metal thread of the conductive mesh pattern 201 is broken only within the gap 24, with very small broken spacing. To the whole capacitive touch panel 10, the conductive mesh pattern 201 is evenly disposed on the whole surface of the substrate 16, thereby providing good visual performance.

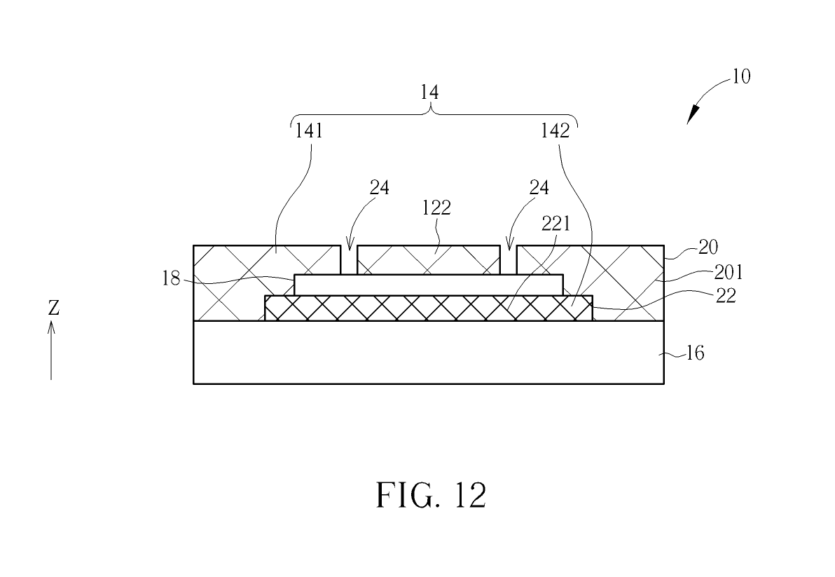

Referring to FIG. 12, FIG. 12 is a schematic diagram illustrating a capacitive touch panel according to a third variant embodiment of the first embodiment of the present invention. The difference between the capacitive touch panel in the third variant embodiment of the first embodiment in the present invention and that of the first embodiment is that the conductive mesh pattern 221 is evenly distributed in the entire first connecting electrodes 142, both in the first portion and the second portions of the first connecting electrodes 142. In other words, each of the first connecting electrodes 142 is not divided into the first portion and the second portions. The area of the first connecting electrodes 142 covered by the insulating layers 18 and the area of the first connecting electrodes 142 not covered by the insulating layers 18 have the same conductive mesh pattern 221. In addition, in this variant embodiment, the geometric shape and/or size of the conductive mesh pattern 221 are different from the conductive mesh pattern 201 of the first conductive mesh layer 20. Nevertheless, in other variant embodiments, the conductive mesh pattern 221 of the first connecting electrodes 142 may be the same as the conductive mesh pattern 201 of the first conductive mesh layer 20 as shown in FIG. 2.

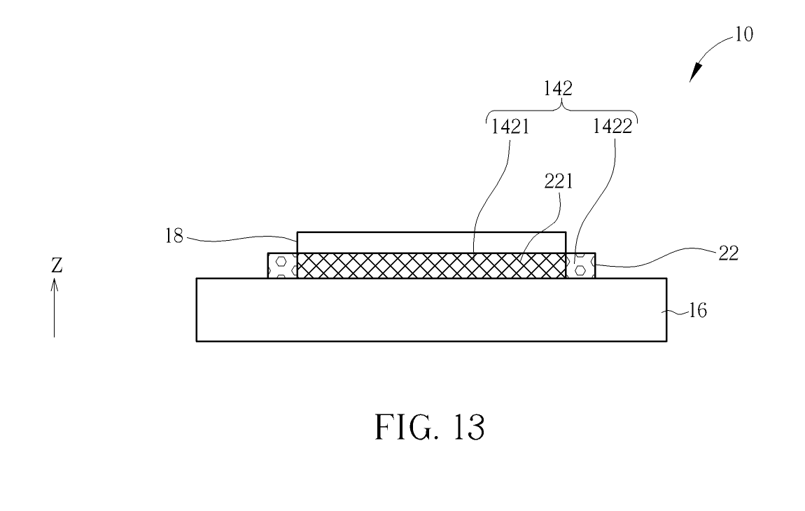

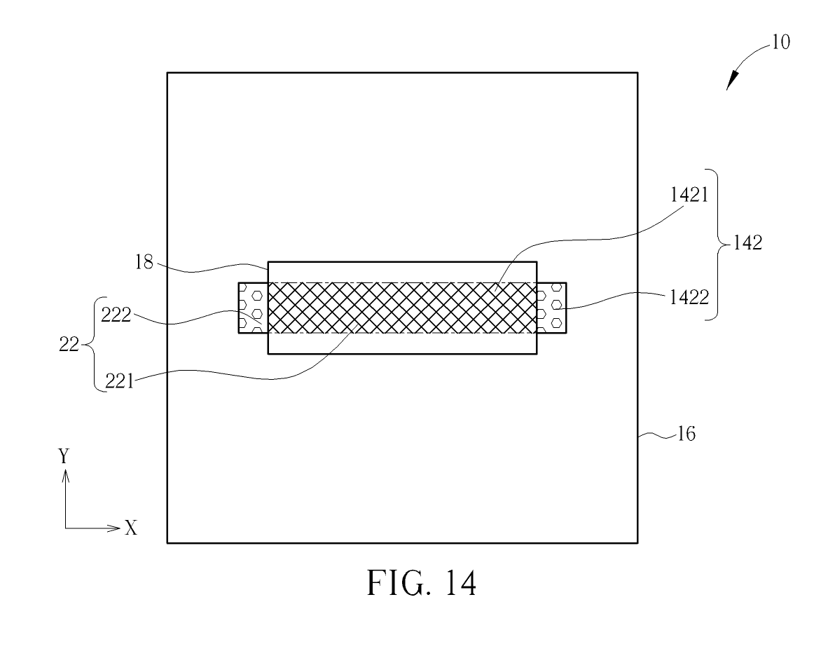

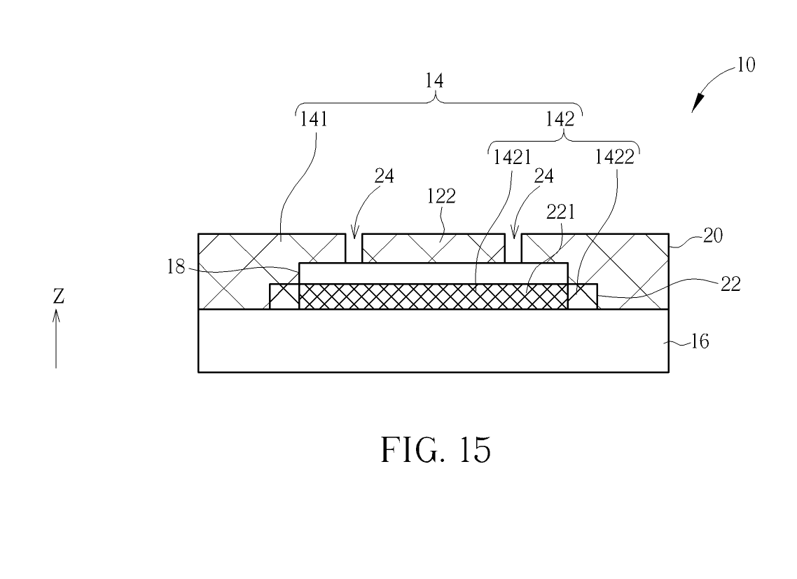

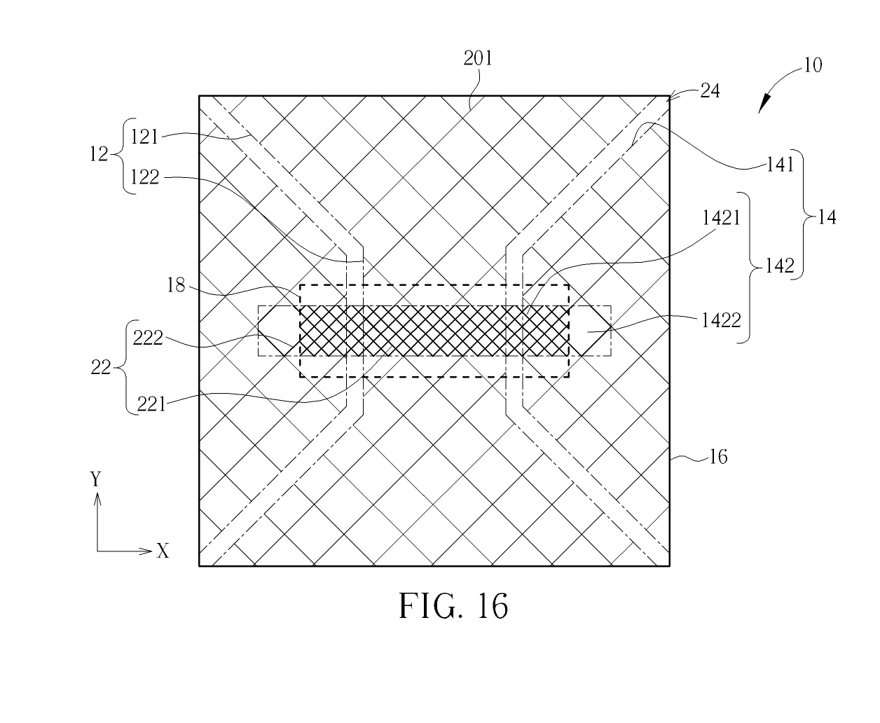

FIGS. 13-16 are process schematic diagrams illustrating a capacitive touch panel according to a fourth variant embodiment of the first embodiment of the present invention. As shown in FIG. 13 and FIG. 14, the conductive layer 22 is formed on the substrate 16. Then, the conductive layer 22 is patterned to form the first connecting electrodes 142. Each of the first connecting electrodes 142 of this variant embodiment includes the first portion 1421 and the second portions 1422. The first portion 1421 includes the conductive mesh pattern 221. The second portions 1422 include metal conductive materials of a stripe or block structure. Subsequently, a plurality of insulating layers 18 is formed on the substrate 16. The portion of each of the first connecting electrodes 142 overlapping the corresponding insulating layer 18 in the direction perpendicular to the plane of the substrate 16 (i.e., the Z direction) is referred to as the first portion 1421. The portions of the first connecting electrodes 142 not overlapping the insulating layers 18 is referred to as the second portions 1422. As shown in FIG. 15 and FIG. 16, the patterned first conductive mesh layer 20 is formed on the substrate 16. The first conductive mesh layer 20 includes a plurality of first electrodes 141, a plurality of second connecting electrodes 122 and a plurality of second electrodes 121. The second electrodes 121, the second connecting electrodes 122 and the first electrodes 141 all have the conductive mesh pattern 201. The method of forming the first conductive mesh layer 20 includes, for example, first forming a metal layer on the whole surface of the substrate 16, and then patterning the metal layer via a photolithography process to remove the metal layer in the gap 24 and to form the conductive mesh pattern 201 with continuously-stacked geometric shapes in the region where the second electrodes 121, the second connecting electrodes 122 and the first electrodes 141 are going to be formed. In the patterning step, the second portions 1422 of the first connecting electrodes 142 exposed by the insulating layers 18 are simultaneously patterned to have the conductive mesh pattern 222. Therefore, the difference between this variant embodiment and the first embodiment is that the block or stripe structure no longer exists in the first portion 1421 of the first connecting electrodes 142 in this variant embodiment. When the first electrodes 141 are accomplished, the whole first connecting electrodes 142 have either the conductive mesh pattern 221 or the conductive mesh pattern 222. And the conductive layer 22 may be regarded as a second conductive mesh layer.

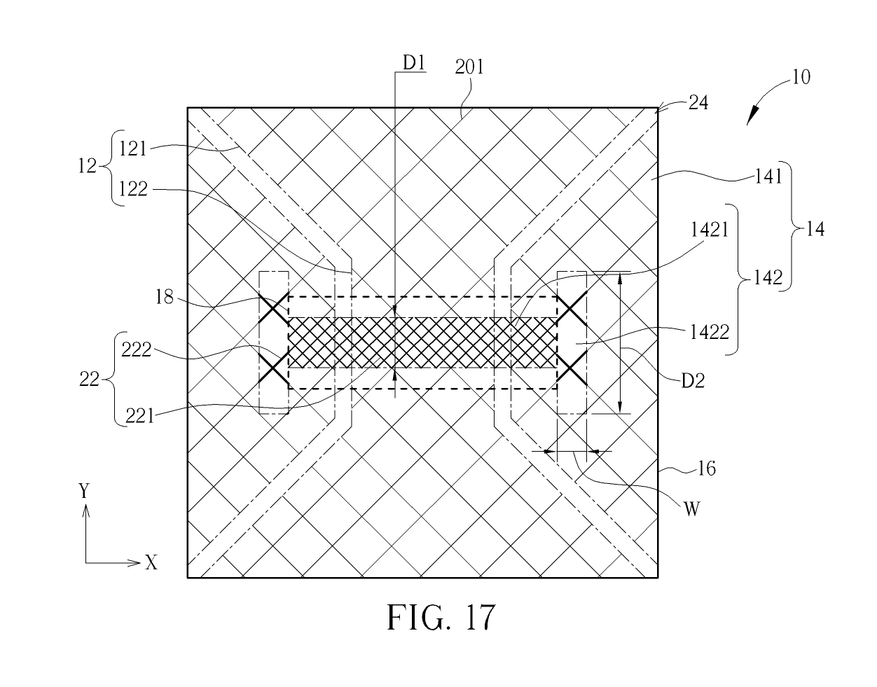

Referring to FIG. 17, FIG. 17 is a top-view schematic diagram illustrating a capacitive touch panel according to a second embodiment of the present invention. The difference between the second embodiment of the present invention and the aforementioned embodiments is that the width D2 of the second portions 1422 of the first connecting electrodes 142 is wider than the width D1 of the first portions 1421. When fabricating the first connecting electrodes 142, the conductive mesh pattern 221 is formed on the first portions 1421, but the metal layer of a block or a stripe shape remains to serve as the second portions 1422. Then, the second portions 1422 are also etched in the photolithography process as the conductive mesh pattern in the first electrodes 141 and the second conductive series 12 is formed so that the second portions 1422 with the larger width D2 have the conductive mesh pattern 222 corresponding are identical to conductive mesh pattern 201 of the first electrodes 141. Furthermore, the width of the metal threads of the conductive mesh pattern 222 may be larger than the width of the metal threads of the conductive mesh pattern 201 so that the overlap area between the second portions 1422 and the first electrodes 141 increases. Accordingly, it prevents the connection between the conductive mesh pattern 221 and the conductive mesh pattern 222 from being broken owing to potential fabrication misalignments, and it also prevents the connection in the overlap between the second portions 1422 and the first electrodes 141 from being broken owing to fabrication or other issues (e.g., photolithography process performance and side-etching), thereby ensuring the final conductivity. In addition, in other embodiments, the length W of the second portions 1422 may be lengthened to enlarge the overlap area between the second portions 1422 and the first electrodes 141 and thus to avoid disconnection.

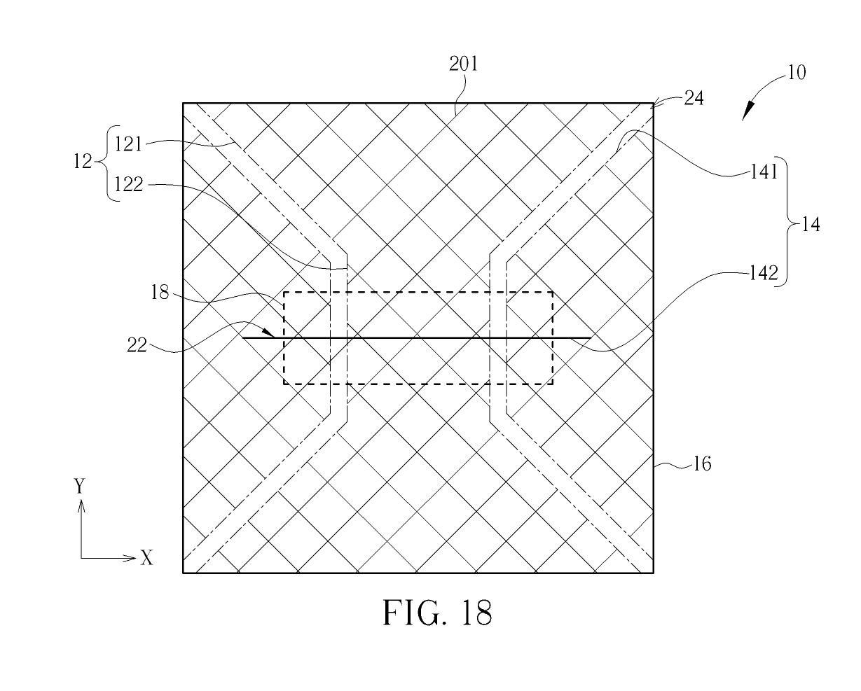

Referring to FIG. 18, FIG. 18 is a top-view schematic diagram illustrating a capacitive touch panel according to a third embodiment of the present invention. The first connecting electrodes 142 of the third embodiment in the present invention are respectively a long metal thread. For example, the width of the metal threads may be less or equal to about 100 micrometers. The portion of each first connecting electrode 142 exposed by the insulating layer 18 connects to the conductive mesh pattern 201 of the corresponding first electrode 141 so as to electrically connect the first electrode 141 to the first connecting electrode 142. In this case, the metal material of the first connecting electrodes 142 beneath the insulating layers 18 becomes less distinct so as to provide a better visual performance.

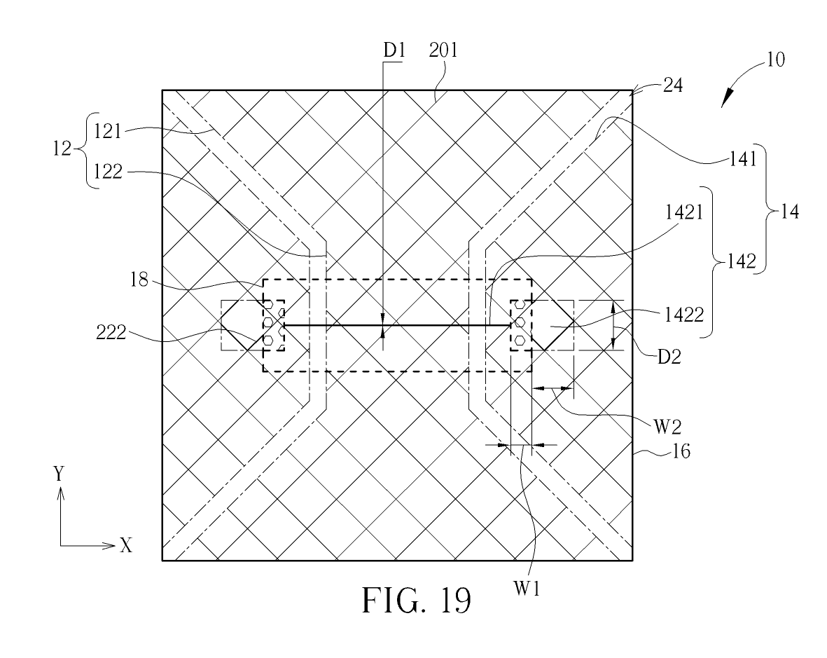

Referring to FIG. 19, FIG. 19 is a top-view schematic diagram illustrating a capacitive touch panel according to a variant embodiment of the third embodiment of the present invention. The difference between the capacitive touch panel of the variant embodiment of the third embodiment of the present invention and that of the third embodiment is that the width of peripheral parts of the first portion 1421, where the first portion 1421 connects the second portions 1422 of the first connecting electrodes 142, is wider. Specifically speaking, the width of peripheral parts of the first portion 1421 equals the width D2 of the second portions 1422 exposed by the insulating layers 18. The width of peripheral parts of the first portion 1421 and the width D2 of the second portions 1422 exposed by the insulating layers 18 are wider than the width D1 in a middle part of the first portion 1421. Accordingly, it prevents disconnection owing to fabrication misalignments or side-etching, and thus the yield rate of the electrically connection between the first connecting electrodes 142 and the first electrodes 141 can be raised. In addition, the length W1 of the first portion 1421 with boarder width (i.e., the peripheral parts of the first portion 1421) and the length W2 of the second portions 1422 may be modified according to design considerations. For example, the length W2 can be lengthened to increase the contact area of the second portions 1422 and the first electrodes 141.

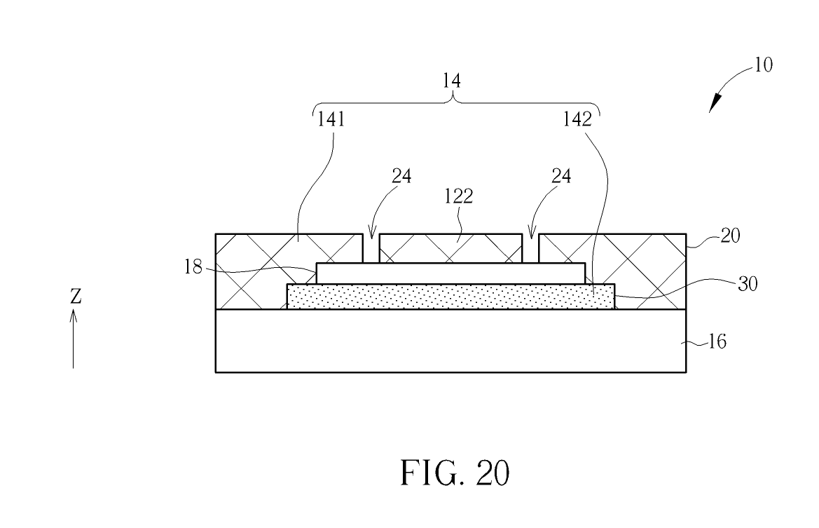

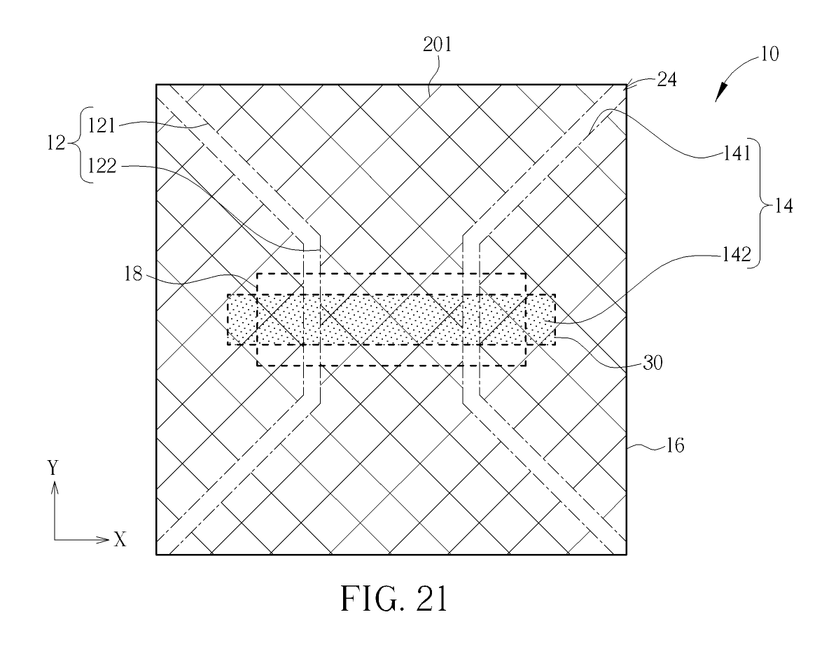

Referring to FIG. 20 and FIG. 21, FIGS. 20-21 are top-view schematic diagrams illustrating a capacitive touch panel according to a fourth embodiment of the present invention. In the fourth embodiment of the present invention, the whole first connecting electrodes 142 are formed from a transparent conductive layer 30. The transparent conductive layer 30 may include transparent conductive materials, such as metal oxide materials like ITO, indium zinc oxide (IZO), or indium tin zinc oxide (ITZO) or other transparent materials with conductivity. In addition, the transparent conductive layer 30 may include inorganic conductive materials, metal conductive materials, oxide conductive materials, carbon nanotube (CNT) conductive materials, metal nanowire conductive materials, metal nanoparticle conductive materials, polymer conductive materials, metal-polymer conductive composites, carbon-polymer conductive composites, or inorganic-polymer conductive composites, but not limited thereto. Take ITO as an example. Because the etchant of ITO is different from that of metal materials in the photolithography process, the transparent conductive layer 30 is not etched as the first conductive mesh layer 20 is being fabricated. After the second electrodes 121, the second connecting electrodes 122 and the first electrodes 141 are formed, the block or stripe structure of the first connecting electrodes 142 maintains. And the portion of each first connecting electrode 142 exposed by the corresponding insulating layer 18 is still electrically connected to and directly in contact with the corresponding first electrode 141.

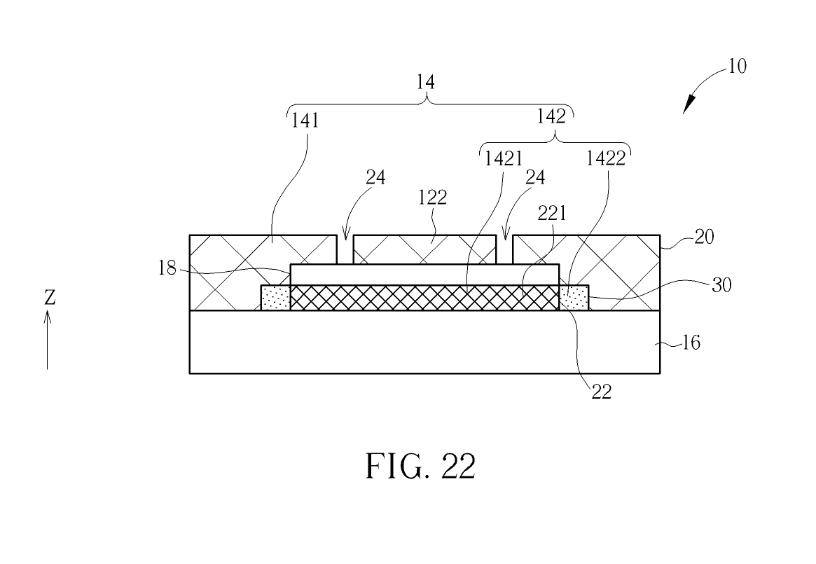

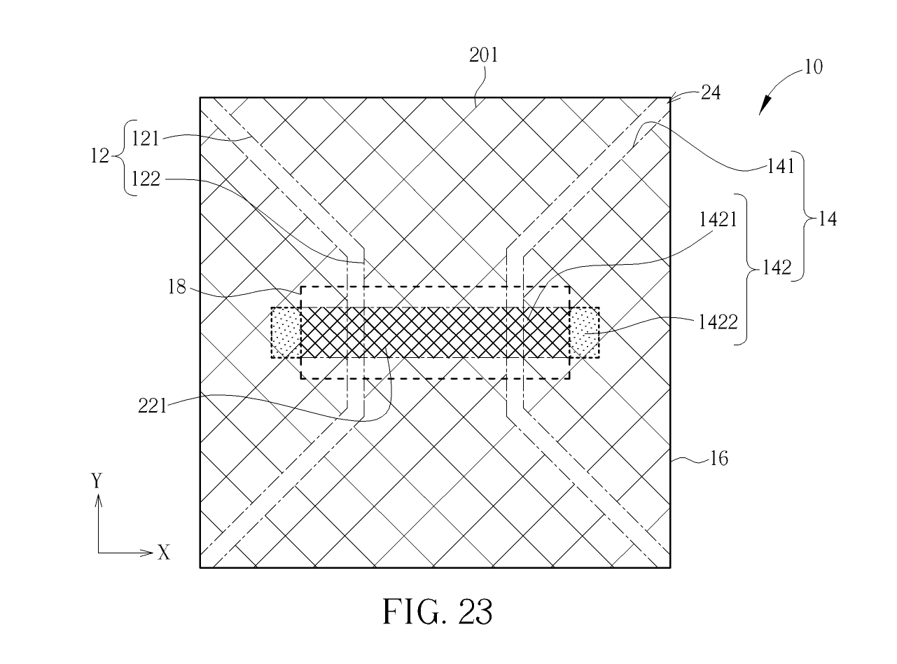

Referring to FIG. 22 and FIG. 23, FIGS. 22-23 are top-view schematic diagrams illustrating a capacitive touch panel according to a fifth embodiment of the present invention. Different from the fourth embodiment, the first connecting electrodes 142 are formed from two different material layers in the fifth embodiment of the present invention. The first portions 1421 of the first connecting electrodes 142 are formed from a conductive layer 22. The second portions 1422 are formed from the transparent conductive layer 30. The conductive layer 22 in this embodiment may be a second conductive mesh layer having the conductive mesh pattern 221 with continuously-stacked geometric shapes, whose material may include those mentioned in the previous embodiments, such as metal materials. The transparent conductive layer 30 may include, for example, the transparent conductive materials aforementioned in the fourth embodiment. Therefore, it will not be redundantly described. As the fourth embodiment, the transparent conductive layer 30 exposed by the insulating layers 18 is not etched when fabricating the first conductive mesh layer 20. As a result, the block or stripe structure of the second portions 1422 of the first connecting electrodes 142 maintains such that the second portions 1422 of the first connecting electrodes 142 are electrically connected to and directly in contact with the first electrodes 141. With the coordinated approach to the second conductive mesh layer, which is the conductive layer 22, and the transparent conductive layer 30, the impedance of the first connecting electrodes 142 can be effectively reduced to provide good electric performance.

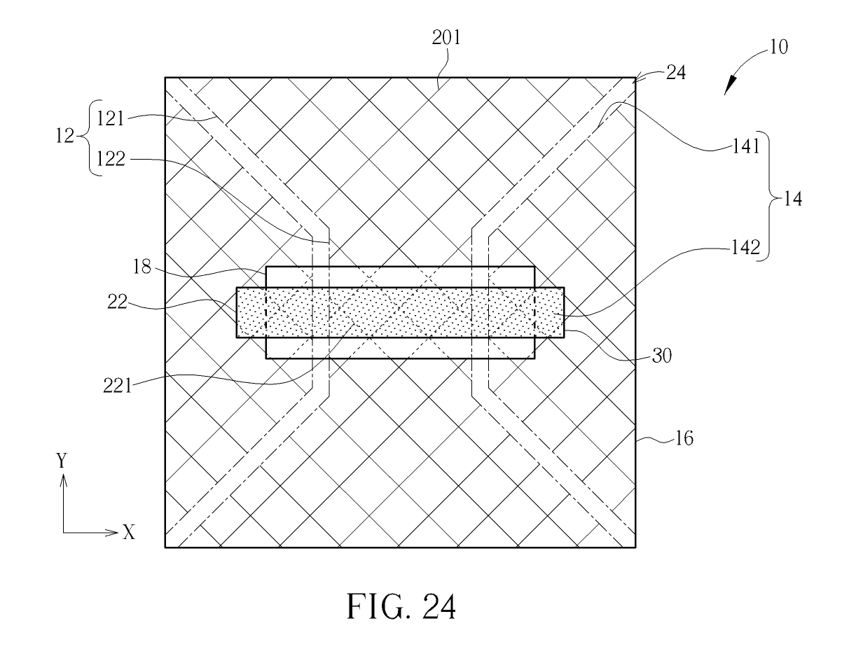

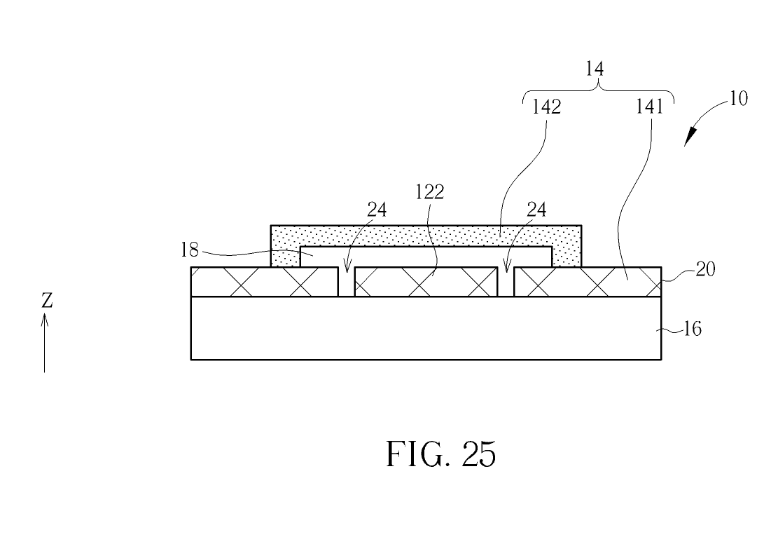

Referring to FIG. 24 and FIG. 25, FIGS. 24-25 are top-view schematic diagrams illustrating a capacitive touch panel according to a sixth embodiment of the present invention. The sixth embodiment of the present invention discloses a method of fabricating the first electrodes 141, the second electrodes 121 and the second connecting electrodes 122 before the first connecting electrodes 142 in the fabrication method of the capacitive touch panel. First, the first electrodes 141, the second electrodes 121 and the second connecting electrodes 122 are formed on the surface of the substrate 16 with the methods detailed in any of the previous embodiments and variant embodiments, wherein the first electrodes 141, the second electrodes 121 and the second connecting electrodes 122 are formed from the first conductive mesh layer 20. Subsequently, the patterned insulating layers 18 are formed on the substrate 16 and cover a portion of the second connecting electrodes 122 and a portion of the first electrodes 141 and at least a portion of the second connecting electrodes 122. A plurality of first connecting electrodes 142 are then formed on the substrate 16 and respectively disposed between two adjacent first electrodes 141 in the same first conductive series 14. The first connecting electrodes 142 are formed from a conductive layer, such as a transparent conductive layer. The material may include, for example, metal oxide materials or any material of the above-mentioned transparent conductive layer 30. Optionally, the first connecting electrodes 142 may be formed from a conductive mesh layer, but not limited thereto.

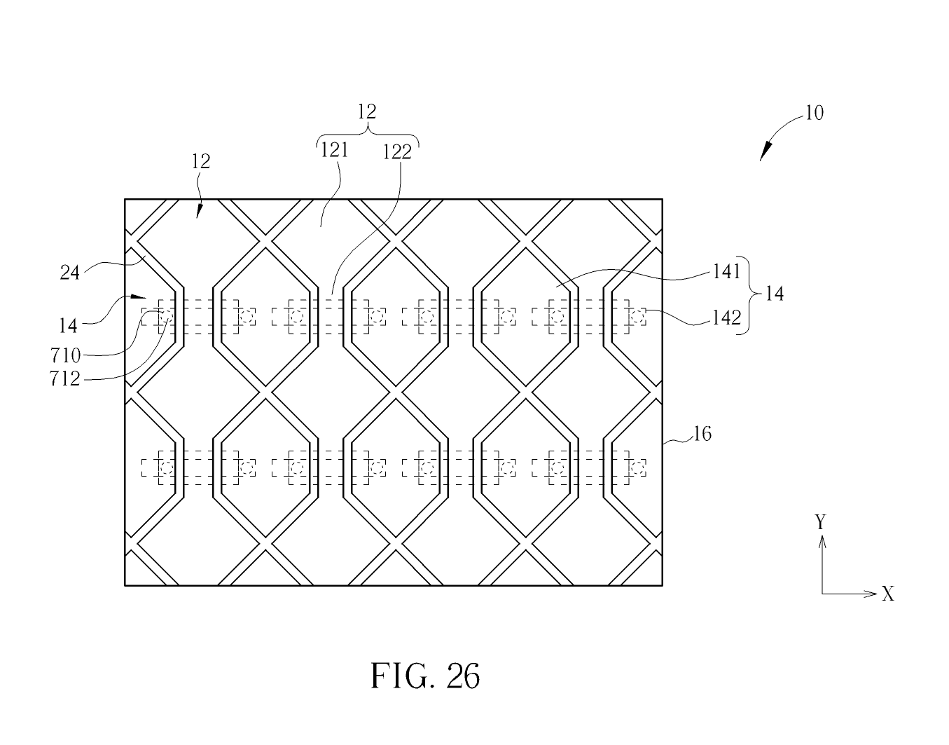

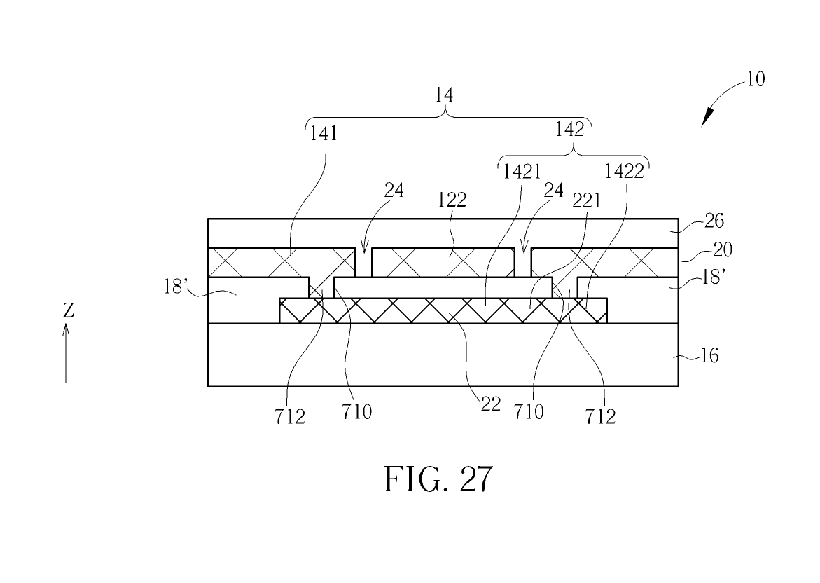

Referring to FIG. 26 and FIG. 27, FIG. 26 is a top-view schematic diagram locally illustrating a capacitive touch panel according to a seventh embodiment of the present invention, and FIG. 27 is a partial cross-sectional view diagram of the capacitive touch panel of FIG. 26. Different from the first embodiment, merely one insulating layer 18′ is disposed on the substrate 16 and extends over the entire plane to cover the first connecting electrodes 142. The insulating layer 18′ has a plurality of openings 710 interposed between the first connecting electrodes 142 and the first electrodes 141 above the corresponding first connecting electrode 142. A connecting plug 712 is further disposed in each opening 710 in order to electrically connect the first connecting electrode 142 and the corresponding first electrodes 141.

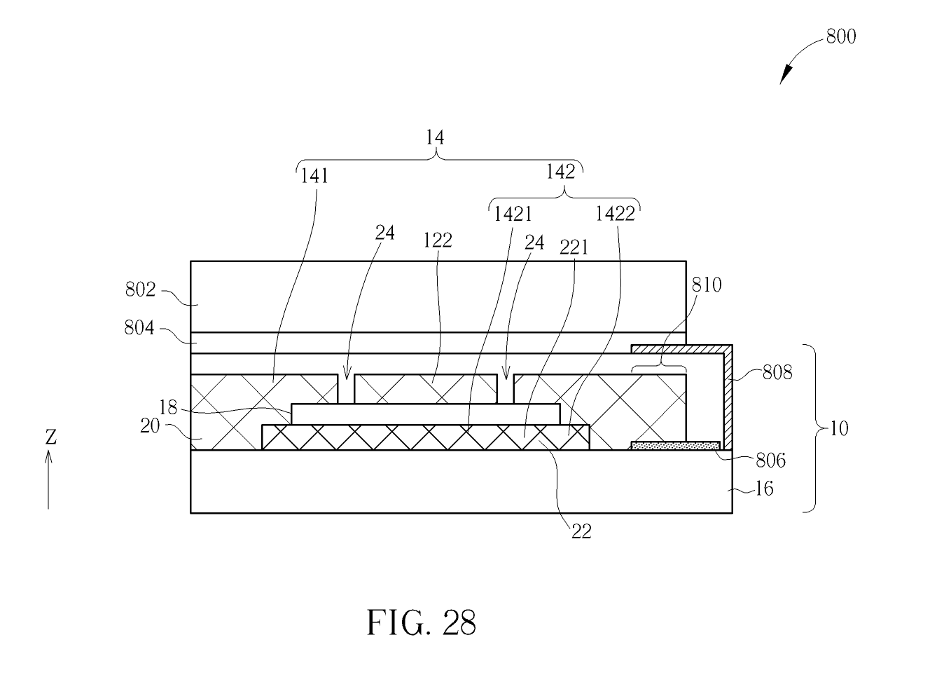

Referring to FIG. 28, FIG. 28 is a partial cross-sectional view diagram of the capacitive touch panel according to an eighth embodiment of the present invention, wherein the capacitive touch panel 10 of this embodiment is an on-glass-solution (OGS) touch panel and is applied to a touch-control display 800. Accordingly, the substrate 16 is a cover lens of the touch-control display 800, and the touch-control display 800 further includes a display panel 802 which is attached onto the capacitive touch panel 10 through an adhesive layer 804. The surface of the substrate 16 opposite to the display panel 802 is the display side of the touch-control display 800. Different from the first embodiment, with the first conductive mesh layer 20, at least one of the first conductive series 14 and the second conductive series 12 extends to form at least ne a trace line 810 with conductive material. For example, the trace line 810 may be disposed in the periphery portion on the substrate 16. It is worth noting that because the trace line 810 and either first conductive series 14 or the second conductive series 12 are formed integrally, the fabrication process may be thus simplified. In this way, the electrical connection between the trace line 810 and either the first conductive series 14 or the second conductive series 12 is assured. In addition, the capacitive touch panel 10 may further comprise a decoration layer 806 disposed peripherally and partially overlap the first and second conductive series 14 and 12. Preferably, the decoration layer 806 is interposed between the trace line 810 and the substrate 16. Furthermore, the capacitive touch panel 10 of this embodiment may further include a light-shielding layer 808 disposed on the passivation layer 26.

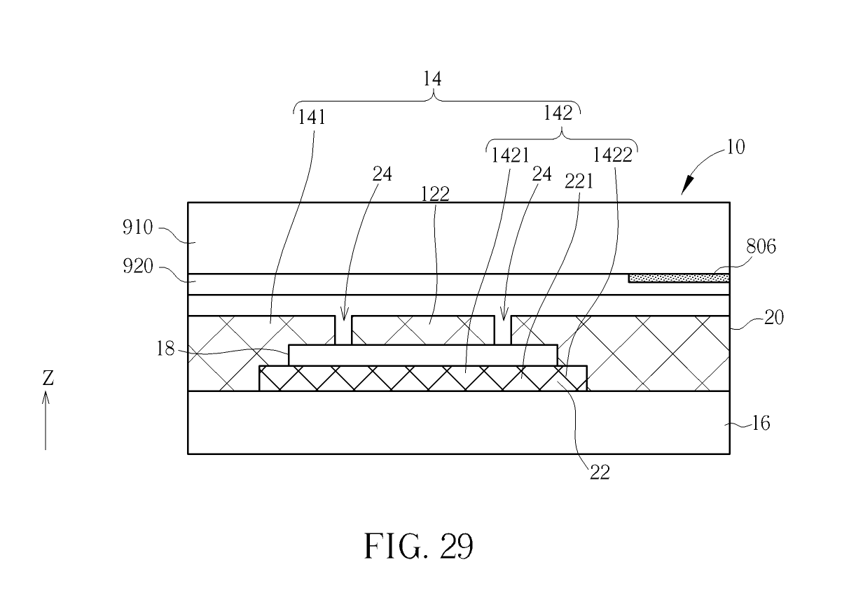

Referring to FIG. 29, FIG. 29 is a partial cross-sectional view diagram of the capacitive touch panel according to a ninth embodiment of the present invention. Different from the first embodiment, the capacitive touch panel 10 of the ninth embodiment may further include a cover plate 910, wherein the cover plate 910 is a transparent plate, such as a glass plate or a plastic plate, and the cover plate 910 can be adhered to the surface of the passivation layer 26 with an adhesive layer 920, for example, optical adhesives. In addition, a decoration layer 806 may be selectively disposed in a periphery portion of the cover plate 910.

To sum up, the axial electrodes in the capacitive touch panel of the present invention comprises conductive mesh materials, for example, with constituent continuously-stacked geometric shape formed from the metal threads with the width less than or equal to about 100 micrometers, thus the impedance of the axial electrodes is uniform and lower to provide good electric performance and optical performance. In different embodiments, the structure or the conductive materials of the second connecting electrodes beneath may be modified to combine with the second electrodes above so as to improve the electrical connection and the overall visual performance and to ensure touch control capability.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A capacitive touch panel, comprising:
a substrate;
at least one first conductive series, disposed on the substrate and extending along a first direction, wherein the first conductive series comprises a plurality of first electrodes disposed along the first direction and a plurality of first connecting electrodes, and each of the first connecting electrodes is disposed between two of the first electrodes adjacent to each other to electrically connect the first electrodes of the first conductive series; and
at least one second conductive series, disposed on the substrate and extending along a second direction, wherein the second conductive series comprises a plurality of second electrodes disposed along the second direction and a plurality of second connecting electrodes, and each of the second connecting electrodes is disposed between two of the second electrodes adjacent to each other to electrically connect the second electrodes of the second conductive series;
wherein at least one of the first electrodes, the second electrodes, the first connecting electrodes and the second connecting electrodes is formed from a conductive mesh layer, the first direction intersects the second direction, and the first conductive series is electrically isolated from the second conductive series.

2. The capacitive touch panel according to claim 1, wherein both the first conductive series and the second conductive series are formed from conductive mesh layers.

3. The capacitive touch panel according to claim 1, further comprising at least one insulating layer disposed between the corresponding first connecting electrode and the corresponding second connecting electrode to electrically isolate the first conductive series from the second conductive series.

4. The capacitive touch panel according to claim 3, wherein each of the first connecting electrodes comprises:
a first portion, wherein the corresponding insulating layer at least covers the first portion; and
two second portions, respectively locating at both ends of the first portion, wherein each of the second portions is electrically connected to one of the first electrodes adjacent to the first connecting electrode.

5. The capacitive touch panel according to claim 3, wherein the insulating layer disposed on the substrate and extends over the entire plane to cover the first connecting electrodes, and the insulating layer has a plurality of openings interposed between the first connecting electrodes and the first electrodes above the corresponding first connecting electrode in order to electrically connect the first connecting electrode and the corresponding first electrodes.

6. The capacitive touch panel according to claim 4, wherein, in each of the first connecting electrodes, a width of at least one part of the first portion is less than a width of the second portions.

7. The capacitive touch panel according to claim 4, wherein, in each of the first connecting electrodes, a conductive mesh pattern of the first portion is different from a conductive mesh pattern of the second portions.

8. The capacitive touch panel according to claim 4, wherein at least one part of the first portion of each of the first connecting electrodes comprises a metal thread.

9. The capacitive touch panel according to claim 8, wherein, in each of the first connecting electrodes, a width of the second portions is larger than a width of the metal thread.

10. The capacitive touch panel according to claim 8, wherein a width of the first portion of each of the first connecting electrodes is substantially the same as a width of the second portions of the first connecting electrode.

11. The capacitive touch panel according to claim 8, wherein, in each of the first connecting electrodes, a width of peripheral parts of the first portion connecting the second portions is larger than a width of the metal thread in a middle part of the first portion.

12. The capacitive touch panel according to claim 4, wherein the first portion in each of the first connecting electrodes comprises a second conductive mesh layer, and the second portions in each of the first connecting electrodes comprise a transparent conductive layer.

13. The capacitive touch panel according to claim 1, wherein only one of the first connecting electrodes and the second connecting electrodes is formed from a conductive mesh layer, and the other one of the first connecting electrodes and the second connecting electrodes is formed from a transparent conductive layer.

14. The capacitive touch panel according to claim 12, wherein the transparent conductive layer comprises metal oxide material.

15. The capacitive touch panel according to claim 13, wherein the transparent conductive layer comprises metal oxide material.

16. The capacitive touch panel according to claim 1, wherein a material of the conductive mesh layer comprises at least one of aluminum (Al), copper (Cu), silver, chromium (Cr), titanium (Ti), molybdenum (Mo), neodymium (Nd), gold (Au), an alloy thereof, a composite layer thereof, and the composite layer of the aforementioned materials and alloys of the aforementioned materials.

17. A fabrication method of a capacitive touch panel, comprising:
forming a patterned conductive layer on a substrate, wherein the patterned conductive layer comprises a plurality of first connecting electrodes;
forming a plurality of patterned insulating layers on the substrate, wherein each of the insulating layers respectively corresponds to and partially covers one of the first connecting electrodes; and
forming a conductive mesh layer on the substrate, the conductive mesh layer comprising:
a plurality of first electrodes, arranged along a first direction to form a plurality of lines, each of the first connecting electrodes being disposed between two of the first electrodes adjacent to each other along the first direction, and each of the first connecting electrodes being configured to electrically connect two of the first electrodes adjacent to the first connecting electrode along the first direction, wherein all the first electrodes and the first connecting electrodes disposed in the same line along the first direction constitute a first conductive series;
a plurality of second electrodes, arranged along a second direction to form a plurality of lines, wherein the first direction intersects the second direction; and
a plurality of second connecting electrodes, respectively disposed between two of the second electrodes adjacent to each other in the same line along the second direction to electrically connect the second electrodes, wherein all the second electrodes and the second connecting electrodes disposed in the same line along the second direction constitute a second conductive series, and each of the first conductive series is electrically isolated from each of the second conductive series.

18. The fabrication method of the capacitive touch panel according to claim 17, wherein a method of forming the conductive mesh layer comprises a screen printing process.

19. The fabrication method of the capacitive touch panel according to claim 17, wherein a method of forming the conductive mesh layer comprises:
forming a metal layer on the substrate to cover the substrate; and
performing a photolithography process for removing a portion of the metal layer to form at least one gap between each of the second conductive series and the first electrodes adjacent to the second conductive series and to form a conductive mesh pattern in the first electrodes, the second connecting electrodes and the second electrodes.

20. The fabrication method of the capacitive touch panel according to claim 19, wherein a portion of the first connecting electrodes exposed by the patterned insulating layers are also etched in the photolithography process to form the conductive mesh pattern in the portion of the first connecting electrodes exposed by the patterned insulating layers simultaneously.

21. A fabrication method of a capacitive touch panel, comprising:
forming a conductive mesh layer on a substrate, the conductive mesh layer comprising:
a plurality of first electrodes, arranged along a first direction to form a plurality of lines;
a plurality of second electrodes, arranged along a second direction to form a plurality of lines; and
a plurality of second connecting electrodes, each of the second connecting electrodes being respectively disposed between two of the second electrodes adjacent to each other in the same line along the second direction to electrically connect the second electrodes, wherein all the second electrodes and the second connecting electrodes disposed in the same line along the second direction constitute a second conductive series;
forming a plurality of patterned insulating layers on the substrate, each of the patterned insulating layers respectively corresponding to and partially covering one of the second connecting electrodes and partially covering two of the first electrodes; and
forming a patterned transparent conductive layer on the substrate, wherein the patterned transparent conductive layer comprises a plurality of first connecting electrodes, each of the first connecting electrodes is respectively disposed between two of the first electrodes adjacent to each other in the same line along the first direction to electrically connect the first electrodes, all the first electrodes and the first connecting electrodes disposed in the same line along the first direction constitute a first conductive series, the first direction intersects the second direction, each of the first conductive series is electrically isolated from each of the second conductive series, and each of the first connecting electrodes partially covers one of the patterned insulating layers.
